(19) United States
(12) Patent Application Publication
(10) Pub. No.: US 2011/0196802 A1
(43) Pub. Date: Aug. 11, 2011

(54) METHOD AND APPARATUS FOR HIRING USING SOCIAL NETWORKS

(76) Inventors: Nicholas Jeremy Ellis, San Francisco, CA (US); Azeem Butt, Redwood City, CA (US)

(21) Appl. No.: 13/019,945

(22) Filed: Feb. 2, 2011

Related U.S. Application Data
(60) Provisional application No. 61/337,767, filed on Feb. 5, 2010.
(60) Provisional application No. 61/332,594, filed on May 7, 2010.

(51) Int. Cl. G06Q 10/00; G06F 17/30

(52) U.S. Cl. 705/321; 707/723; 707/E17.107

(57) ABSTRACT

A computing device generates job search results for a user. The computing device accesses a social network account of the user to determine employers of contacts in the user's social network. For each job search result, the computing device determines a number of contacts in the user's social network that work for an employer associated with the job search result. The computing device then ranks the job search results based at least in part on the number of contacts in the user's social network that work for employers associated with the job search results. The computing device then provides the ranked search results to the user.

### RELATED APPLICATIONS

This patent application claims the benefit under 35 U.S.C. §119(e) of U.S. Provisional Application No. 61/337,767, filed Feb. 5, 2010, and U.S. Provisional Application No. 61/332,594, filed May 7, 2010, which are herein incorporated by reference. This patent application is related to co-pending U.S. patent application Ser. No. ______, filed Feb. 2, 2011, entitled, “Method And Apparatus For Hiring Using Mobile Phones.”

### BACKGROUND OF THE INVENTION

Many people seeking jobs often have difficulty finding information on the very jobs they seek. For example, in the United States, about a fifth of Americans don't have Internet access at home. This figure correlates closely with the demographics of those suffering the fastest rises in unemployment. This population of people that cannot access a computer are disadvantaged by their lack of information. With no easy-to-access, affordable information service through which to apply for a job, approximately 4 billion of the world's 6 billion people have difficulty finding a job.

Employers are frequently forced to review each resume submitted by a job seeker for a particular job. Conventional hiring systems do not enable an employer to distinguish between multiple job seeker's qualifications. For example, if an employer were to request resumes for a new store clerk, the employer would typically need to review each resume to identify the ideal candidate based on the employer's subjective requirements. This process is time-intensive and expensive.

Accordingly, current hiring systems are inefficient and fail to effectively utilize the abilities of mobile phones.

### BRIEF DESCRIPTION OF THE DRAWINGS

The embodiments described herein will be understood more fully from the detailed description given below and from the accompanying drawings, which, however, should not be taken to limit the application to the specific embodiments, but are for explanation and understanding only.

FIG. 1 is a block diagram of an exemplary network architecture, in accordance with one embodiment of the present invention.

FIG. 2 is a block diagram of one embodiment of a mobile job server.

FIG. 3A illustrates an online form that a job seeker may fill out upon subscribing to a mobile job server, in accordance with one embodiment of the present invention.

FIG. 3B illustrates a block diagram showing a user session for generating a user account, in accordance with one embodiment of the present invention.

FIG. 4 illustrates a form that an employer or recruiter may fill out to generate a job posting, in accordance with one embodiment of the present invention.

FIG. 5 illustrates an example job posting before it has been reformatted, in accordance with one embodiment of the present invention.

FIG. 6 illustrates a reformatted job posting, in accordance with one embodiment of the present invention.

FIG. 7 illustrates an example survey that has been generated for the job posting of FIG. 5, in accordance with one embodiment of the present invention.

FIG. 8 illustrates trend data for a particular job posting, in accordance with one embodiment of the present invention.

FIG. 9 is a flow diagram of one embodiment for a method of sending job postings to mobile devices.

FIG. 10 is a flow diagram of one embodiment for a method of ranking job postings.

FIG. 11 is a flow diagram of one embodiment for a method of conducting surveys using mobile devices.

FIG. 12 illustrates a block diagram showing a user session associated with a particular job position, in accordance with one embodiment of the present invention.

FIG. 13 is a flow diagram of one embodiment for a method of helping a job applicant improve his/her qualifications for job postings.

FIG. 14 is a flow diagram of one embodiment of a method for validating a job seeker's responses to qualification questions in a survey.

FIG. 15 is a flow diagram of one embodiment of a method for generating ranked candidate pools.

FIG. 16 is a block diagram illustrating an exemplary server computing device.

### DETAILED DESCRIPTION OF THE PRESENT INVENTION

Methods and systems for facilitating the hiring of new employees using mobile phones are described. In one embodiment, a computing device generates job search results for a user. The job search results may be generated by performing a search for job postings based on user specified criteria. The computing device accesses a social network account of the user to determine employers of contacts in the user's social network. For each job search result, the computing device determines a number of contacts in the user's social network that work for an employer associated with the job search result. The computing device then ranks the job search results based at least in part on the number of contacts in the user's social network that work for employers associated with the job search results. The computing device then provides the ranked search results to the user.

Mobile phones present a unique opportunity to deliver employment information to job seekers in a way that is a geographically targeted, quick, familiar, and affordable. Because mobile phones are more affordable, pervasive, reliable, and real-time than computers, they can enable a user to better respond to local trends in labor markets than competing online solutions. Embodiments of the present invention describe a method and apparatus that allows job seekers to apply to jobs using their mobile phones (e.g., using short-messaging service (SMS) text messages). This brings employment information to job seekers who do not have access to computers or Internet service, and allows job seekers and employers to interact quickly, cost-effectively, and in a coordinated fashion. Embodiments of the invention combine contextual information (e.g., location, time, etc.) and factual information (e.g., user-generated responses to questions) to better recommend jobs to job seekers, more intelligently and quickly identify the most qualified job seekers for particular positions, and identify trends in job seeker behavior as they pertain to particular employers, employment openings, and industries. Accordingly, embodiments of the present invention may enhance and improve applicant tracking systems (ATSs) such as Taleo® or Kenexa® and job listing systems such as Monster.com® and Beyond.com®.

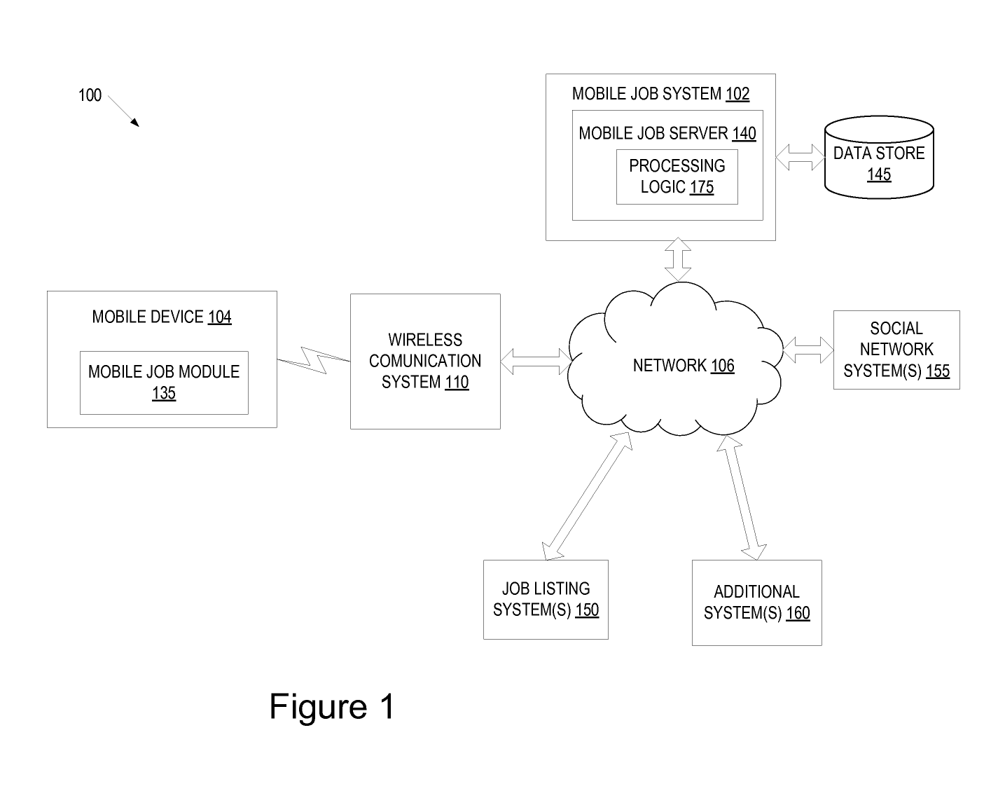

FIG. 1 is a block diagram of an exemplary network architecture 100, in which embodiments described herein may operate. The network architecture 100 may include a mobile job system 102 that is connected with one or more job listing systems 150, social network systems 155 and/or additional systems 160 via a network 106. The network 106 may be a public network (e.g., the Internet), a private network (e.g., a local area network (LAN), wide area network (WAN), etc.), or a combination of public and/or private networks.

Mobile job system 102 provides job search capabilities to mobile devices 104 of users. The mobile job system 102 includes a network-accessible server-based functionality (e.g., mobile job server 140 and/or processing logic 175), various data stores 145, and/or other data processing equipment. Mobile job system 102 may be implemented by a single machine or a cluster of machines. Mobile job system 102 may include one or more machines (e.g., one or more server computer systems, routers, gateways, data stores 145, etc.) that have processing and storage capabilities to provide the server-based functionality.

Mobile job server 140 delivers job search results (e.g., job postings), alerts, surveys, and/or other information to mobile devices 104 via the network 106. Such job postings, surveys and additional information may be uploaded directly to mobile job system 102 by employers, recruiters, surveyors, or other entities. Additionally, mobile job server 140 obtains job postings, surveys and/or other information from other systems via network 106. In one embodiment, mobile job server 140 includes processing logic 175 for performing one or more functions described herein. Alternatively, processing logic may be separate from mobile job server 175. Processing logic 175 may comprise hardware (circuitry, dedicated logic, etc.), software (such as is run on a general purpose computer system or a dedicated machine), or a combination of both.

Mobile job server 140 obtains job posting information from the one or more job listing systems 150. Examples of job listing systems 150 include Monster.com®, Beyond.com®, EmploymentGuide.com®, snagajob.com®, jobs.aol.com®, hotjobs.yahoo.com®, and so forth. Each job listing system may provide a system specific application programming interface (API), XML feed, or other web object that can be digitally interpreted for accessing job postings. APIs may enable mobile job server 200 to perform searches on job postings provided by the job listing systems 150. Mobile job server 200 may use the APIs to download specific job postings (e.g., job postings satisfying search criteria) or all job postings from the job listing systems 150. Additionally, some job listing systems 150 may provide subscription feeds such as real simple syndication (RSS) feeds, Atom feeds, and extensible markup language (XML) data feeds. Mobile job server 140 may subscribe to such subscription feeds to receive new job postings as those job postings are added to the job listing systems 150. Mobile job server 200 may subscribe to subscription feeds associated with specific categories of job postings (e.g., based on industry, geographic location, etc.) or to general subscription feeds that send all new job postings to subscribers. In one embodiment, mobile job server 140 additionally accesses web pages that provide job listings and record the job posting information included in these web pages (e.g., by performing data scraping). Other techniques for obtaining job posting information from job listing systems 150 may also be used (e.g., telnet, file transfer protocol (FTP), etc.).

In one embodiment, mobile job server 140 obtains information about users' social networks from one or more social network systems 155. Mobile job server 140 may also connect to social network systems 155 to post job postings or other information to social network accounts of users. Mobile job server 140 may use Open Authorization (OAuth) to access information for a user from the social network systems 155. OAuth is a handshake protocol that social networking systems 155 use to exchange information. OAuth allows systems to hand out tokens instead of credentials to their data hosted by a given service provider. Each token grants access to a specific site (e.g., a social network site) for specific resources (e.g., contact information). Examples of social network systems 155 to which mobile server 140 may connect include Friendster®, Facebook®, MySpace®, LinkedIn®, etc.

In one embodiment, mobile job server 140 connects to additional systems 160 to obtain additional information, such as advancement opportunity information. Mobile job server 140 may connect to web servers for educational institutions (e.g., adult education schools, community colleges, certifying agencies, drivers training schools, universities, colleges, etc.), volunteer and nonprofit organizations, and so forth. Mobile job server 140 may query these additional systems 160 for information regarding certification programs, volunteer opportunities, licensing programs, classes, etc. Each such volunteer opportunity, program, class, program, etc. may be associated with a particular job skill or job skills and may be recommended to the end user based on their previous responses to questions defined by the employer. In one embodiment, priority is given to advancement information that directly relates to the least-qualified response provided by an end-user as compared to the larger response set from other users.

Mobile device 104 may be a portable electronic device such as a mobile phone. The mobile phone may be a basic mobile phone that can send and receive voice phone calls and short messaging system (SMS) text messages. The mobile phone may alternatively be a more advanced mobile phone such as a so called smart phone, which may include an operating system, installed applications, and so forth in addition to capabilities for handling SMS text messages and voice phone calls. Other examples of mobile devices include tablet computers, electronic book readers, personal digital assistants (PDAs), portable media players, netbooks, laptops, and the like.

Mobile device 104 connects to network 106 wirelessly via a wireless communication system 110. Wireless communication system 110 may be a wireless fidelity (WiFi) hotspot connected with network 106. Alternatively, wireless communication system 110 may be a wireless carrier system that can be implemented using various data processing equipment, communication towers, etc. Alternatively, or in addition, the wireless carrier system 110 may rely on satellite technology to exchange information with the mobile device 104. Examples of wireless carrier systems include those offered by Sprint®, Verizon®, Vodaphone®, T-Mobile®, etc.

Mobile job server 140 and mobile device 104 may communicate synchronously and/or asynchronously over online and offline environments. In one embodiment, mobile job server 140 generates messages (e.g., SMS messages) that include job posting information, survey questions, alerts, etc. and sends the messages to wireless communication system 110, which may then send the messages to mobile device 104. The information may include discrete qualitative and quantitative data that was gathered for a user of mobile device 104, and may further include recommendations that can be highly contextual.

Mobile device 104 may also send messages that include survey responses, requests for information, requests to apply to job postings, etc. to wireless communication system 110, which then forwards these messages to mobile job server 140. This allows a user to use the mobile device 104 to receive job postings, fill out surveys, apply for jobs, etc. without being tethered to mobile job system 102 via hardwired links. In one embodiment, all messages sent to mobile device 104 and all responses sent to mobile job server 140 are SMS messages. Therefore, a user may receive job alerts, fill out job related surveys and apply for jobs all using SMS on their mobile device 104. Additionally, job seekers may promote and redistribute job information they receive on their mobile device 104 phone to online communities. The mobile job system 102 allows individuals and workforce systems to interact and exchange information anytime and anywhere so as to optimize individual employment opportunities, thus reducing unemployment in communities of operation and use.

In one embodiment, the mobile device 104 includes a mobile job module 135. Mobile job module 135 is a program or application configured to communicate with mobile job server 140. Mobile job module 135 can read and/or perform operations with respect to job postings, surveys, alerts, and other types of messages received from mobile job server 140. Alternatively, mobile device 104 may communicate with mobile job server 140 using native capabilities of the mobile device (e.g., SMS or voice for a mobile phone).

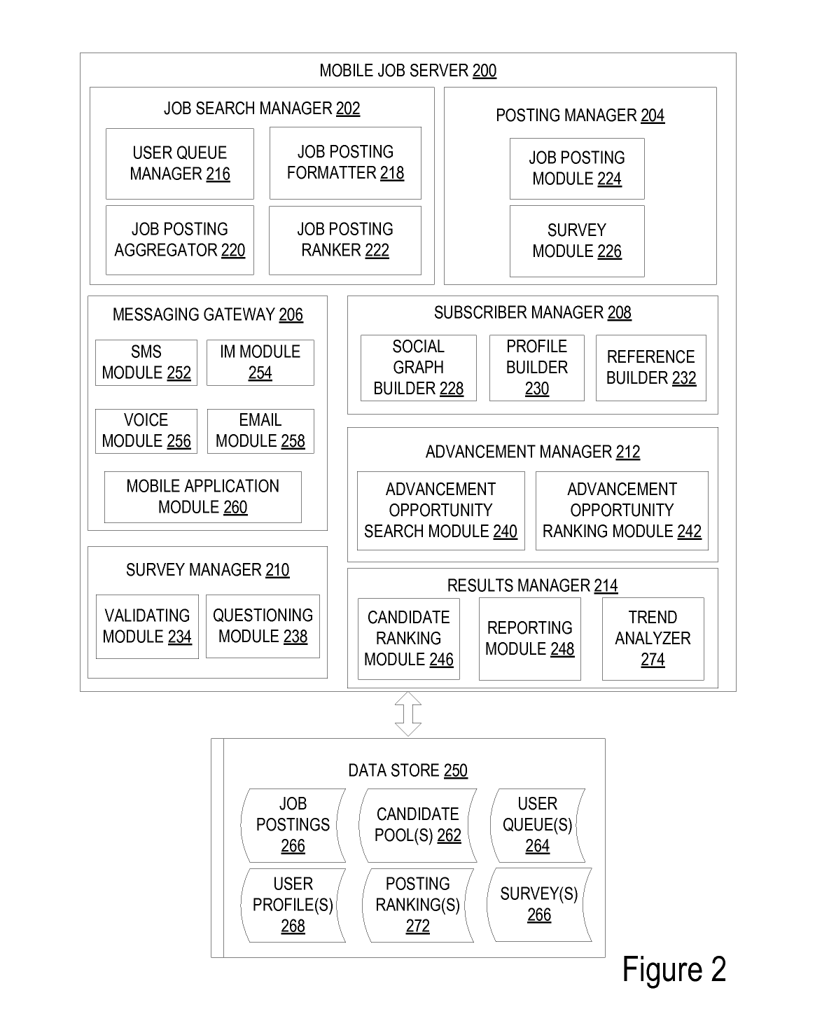

FIG. 2 is a block diagram of one embodiment of a mobile job server 200, which may correspond to the mobile job server 140 of FIG. 1. In one embodiment, the mobile job server 200 includes a job search manager 202, a posting manager 204, a subscriber manager 208, a survey manager 210, an advancement manager 212, a results manager 214 and a messaging gateway 206. In other embodiments, the functionality of one or more of the described managers, gateway and other modules may be combined. Additionally, the functionality of one or more of these modules may be separated into multiple additional modules.

In one embodiment, mobile Job server 200 is connected to one or more data stores 250. The data store 250 may include volatile storage and/or non-volatile storage. The data store 250 may include internal storage of a server computing device or network storage such as a network attached storage (NAS) and/or a storage area network (SAN). In one embodiment, data store 250 includes one or more databases (e.g., relational databases) having specified schemas. Data store 250 may include candidate pools and other job posting trend data (referred to simply as candidate pools 262), user queues 264, job postings 266, posting rankings 272, surveys 266 and/or user profiles 268.

The mobile job server 200 can interpret and process natural language inquiries and responses in real-time in simultaneous succession. The mobile job server 200 can combine contextual information encoded messages and factual qualitative information provided by users to create a more targeted job search experience. Contextual data is passive data encoded with the messages. Examples of contextual data are a job seeker's current location (e.g., as sent via a geo-code from the mobile device) and the date and time a message was sent. Qualitative data is user generated data. Examples of qualitative data include target salary range, target sectors of employment, distance the job seeker is willing to travel for work, and user responses to questions. Based on the contextual and qualitative data, the mobile job server 200 can geographically target employment information that is relevant to the user.

Subscriber manager 208 manages user subscriptions to mobile job server 200. Users may be divided into job seekers (also referred to herein as candidates or applicants) and employers (which may also include recruiters). Different options may be provided to each category of user. Subscriber manager 208 allows users to set up a user account and perform other administrative functions. The subscriber manager 208 includes or has access to user information, including user login and password information.

When subscriber manager 208 generates a new job seeker account, subscriber manager 208 may ask the job seeker a series of questions to enable mobile job server 200 to determine job postings that are most relevant for the job seeker. Subscriber manager 208 may ask the job seeker to identify a location where the job seeker wants to work, an industry in which the job seeker wants to work, one or more key words to use in job searches, a desired salary range, etc. The job seeker may also be asked to provide information for one or more social network accounts of the job seeker.

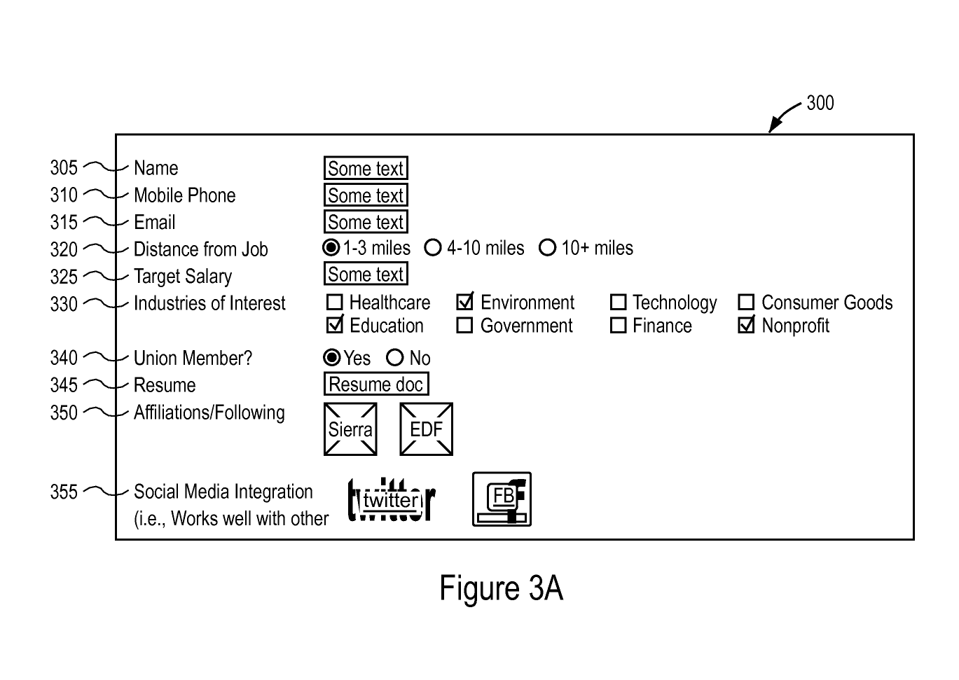

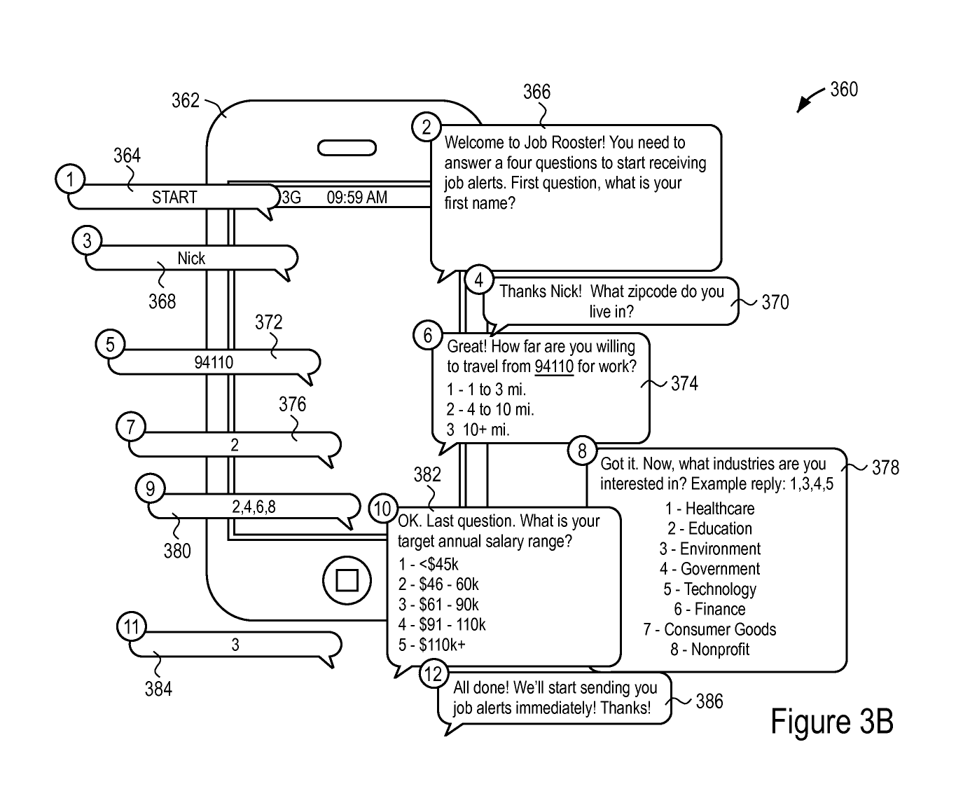

FIG. 3A illustrates an online form 300 that a job seeker may fill out upon subscribing to mobile job server 200, in accordance with one embodiment of the present invention. As shown, a new user may be required to enter his name 305, mobile phone number 310, email address 315, maximum distance from input location to job 320, industries of interest 330, union membership 340, etc. The user may also be required to upload a resume 345 and/or identify any organization affiliations 350. In one embodiment, the user is asked to provide information about social network accounts to enable social media integration 355. Note that the geographic, industry, salary and/or other constraints particular to a job seeker may be updated at any time. In addition to subscribing to the mobile job server 200 online, users may also subscribe using their mobile devices.

FIG. 3B illustrates a block diagram 360 showing a user session for generating a user account, in accordance with one embodiment of the present invention. The user session includes a series of messages and responses sent back and forth between a mobile phone 362 of the user and a mobile job server. The session begins with mobile phone 362 sending a subscribe request to the mobile job server (block 364). The user then receives a first question asking the user's name at block 366. At block 368, the user responds with his name. At block 370, user receives a second question asking his zip code. At block 372, the user answers with his zip code. At block 374, the user is asked how far he is willing to travel to work. At block 376, the user sends “2” to indicate that he is willing to travel 2-4 miles. At block 378 the user receives a third question asking what industries he is interested in. At block 380, the user sends “2,” “4,” “6,” and “8” to indicate that he is interested in education, government, finance and nonprofit work. At block 382, the user receives a fourth question asking his target salary range. At block 384, the user sends “3” to indicate that his desired salary range is $61K-90K. The user then receives a confirmation message at block 386 and the session terminates.

Returning to FIG. 2, in one embodiment, subscriber manager 208 includes a profile builder 230. Profile builder 230 builds user profiles 268 for job seekers. A user profile 268 may begin with user answers to questions asked at account generation (e.g., such as location, salary requirements, industry, etc.). Additionally, as the job seeker applies to job postings, information associated with the applications may be added to the user profile 268. For example, the job seeker may be asked qualification questions for a job posting. User answers to these qualification questions may be stored in the user profile 268, and may be used to further define job matches.

In one embodiment, subscriber manager 208 includes a reference builder 232. A user may add one or more references using reference builder 232. The user may add a reference name and contact information (e.g., phone number, email address, etc.). In one embodiment, the user is asked to provide a mobile phone number of the reference. This enables mobile job server 200 to send reference requests to the reference using the same mechanisms that mobile job server 200 uses to deliver job postings to users. The user may also add more detailed reference information, such as the reference's employment history, relation to the reference, etc. In one embodiment, reference builder 232 adds reference information to the user profile 268.

In one embodiment, subscriber manager 208 includes a social graph builder 228. Social graph builder 228 accesses the user's social network accounts to acquire the user's contact information. Social graph builder 228 may use OAuth to access one or multiple social network accounts of the user. Contact information such as contact name, current employment information and past employment information for the user's contacts may be downloaded. Social graph builder 228 may then build a social graph based on the acquired contact information. Social graph builder 228 may add the social graph to the user's user profile 268.

In one embodiment, social graph builder 228 identifies redundant or conflicting entries in the social graph. Social graph builder 228 then resolves the conflict and/or redundancy by merging the conflicting/redundant entries into a single entry. Alternatively, social graph builder may simply delete one of the conflicting/redundant entries. For example, if a user has a contact entry for Bob Jenkins from his Facebook account and another contact entry for Bob Jenkins from his LinkedIn account, these two entries may be merged. This may include combining information from the two entries. Where information is in conflict, most recent information may be used.

Posting manager 204 manages adding, removing and updating job postings and survey postings. Posting manager 204 provides a user interface by which employers and pollsters may generate and/or upload job postings and survey postings. In one embodiment, posting manager 208 includes a job posting module 224 and a survey module 226. Job posting module 224 includes a user interface that users can interact with to build new job postings and modify existing job postings. Via the job posting module 224, users may add a job posting description, add qualification questions, add salary information, add job requirements and duties, etc. Similarly, survey generator 226 includes a user interface that users can interact with to generate new surveys and modify existing surveys. Newly generated job postings 266 are stored along with other job postings 266 in data store 250. Additionally, newly generated surveys 270 may be stored along with other surveys 270 in data store 250.

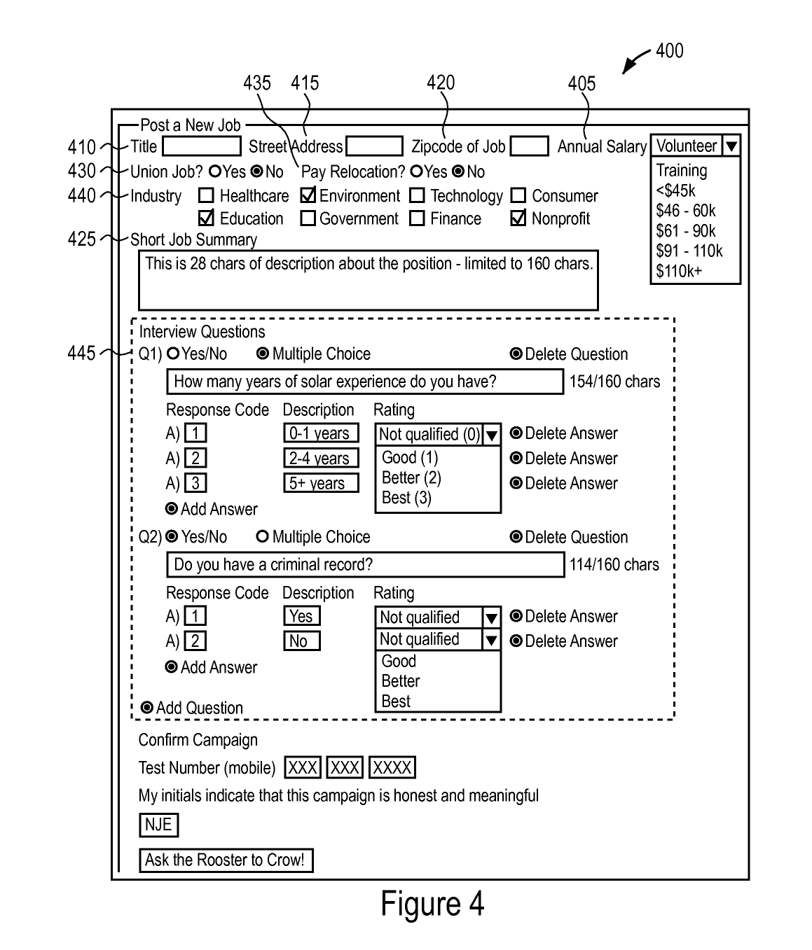

FIG. 4 illustrates a form 400 that an employer or recruiter may fill out to generate a job posting, in accordance with one embodiment of the present invention. As shown, the form 400 includes multiple form fields. Some form fields may include drop down menus, such as a form field for annual salary 405. Other form fields may include text boxes, such as a title form field 410, street address form field 415, zip code form field 420, and short job summary form field 425. Still other form fields may include check boxes that can be checked or unchecked, such as a pay relocation form field 435, union job form field 430 and industry form field 440. Other possible fields include language requirements, job posting expiration date, publishing options (e.g., all users, specific classes of users, only users following the employer, etc.). In one embodiment, form 400 also includes a keyword (not shown) that is either dynamically generated or user-defined. In either case, the keyword may be a unique and temporary value that enables the information in the form 400 to be “pulled” by an end-user by sending the assigned keyword to the mobile job server 200.

In one embodiment, form 400 includes an interview questions (also referred to herein as qualification questions) section 445. The qualification questions section 445 enables a user to add qualification questions to a job posting. Such qualification questions may be yes/no questions, multiple choice questions or free form questions. For each qualification question, the user may input the question and one or more possible answers (e.g., for yes/no and multiple choice questions). The user may additionally assign a scoring value for each of the possible answers. For example, the question may be, “how many years of solar experience do you have,” and the answers may be “0-1 years,” “2-4 years,” and “5+ years.” A user may assign a score of 1 to the “0-1 years” answer, a score of 2 to the “2-4 years” answer, and a score of 3 to the “5+ years” answer. If a job applicant were to answer this survey question with “0-1 years,” the applicant would be given one point. Applicants may accrue points based on answers to multiple qualification questions. The applicants may then be ranked based on their aggregated qualification question response scores.

Returning to FIG. 2, job search manager 202 collects job postings and performs job searches for users. Job search manager 202 may create a natural language, real-time, and social job search experience for the users. In one embodiment, job search manager 202 includes a job posting aggregator 220, job posting formatter 218, job posting ranker 222 and user queue manager 216.

Job posting aggregator 220 retrieves job postings from one or more job listing systems. Job posting aggregator 220 may use APIs, RSS feeds, Atom feeds, XML feeds, etc. provided by the job listing systems to retrieve the job postings. Retrieved job postings 266 are then stored in data store 250. In one embodiment, job postings 266 are stored in a database having a schema optimized for job searches. The schema may include attributes for salary, industry, location, employer, qualifications, and so forth. Job postings may be searched using any of these attributes as search keys.

Each job listing system may provide job postings in a different format. Additionally, each employer may generate job postings using a different format. Typically, job postings are provided in a format optimized for presentation on a computer monitor via a web browser. In one embodiment, job posting formatter 218 reformats retrieved job postings into a standardized format that is optimized for presentation on mobile devices such as mobile phones. This may include making job postings more concise by paring down unnecessary language and information. This may also include dividing the job posting into multiple components or pages. In one embodiment, job posting formatter 218 formats job postings for use with short messaging service (SMS). This may include dividing the job posting into a collection of 160 character pages.

Job posting reformatter 218 includes a parser that can break the job posting into component pieces and arrange the pieces into a structure that is presentable on mobile devices, which typically have reduced viewing areas, and which may have character limitations (as with SMS). In one embodiment, to reformat a job posting, job posting reformatter 218 parses the job posting. Job posting reformatter 218 analyzes the parsed job posting, and classifies passages in the job posting. Each passage may be a word, series of words and/or characters, sentence, paragraph, etc. Job posting reformatter 218 then divides the job posting into a collection of portions, where each portion corresponds to a particular classification. Example classifications include job requirements, summary/overview, job duties, detailed job description, additional information, etc. Job posting reformatter 218 may generate a separate page or series of pages for each portion. In one embodiment, job posting reformatter 218 links the portions, so that each portion is accessible from at least one of the other portions. For example, a user may navigate from the general overview portion to an employer information portion by pressing “e”, or to a job requirements portion by pressing “r.”

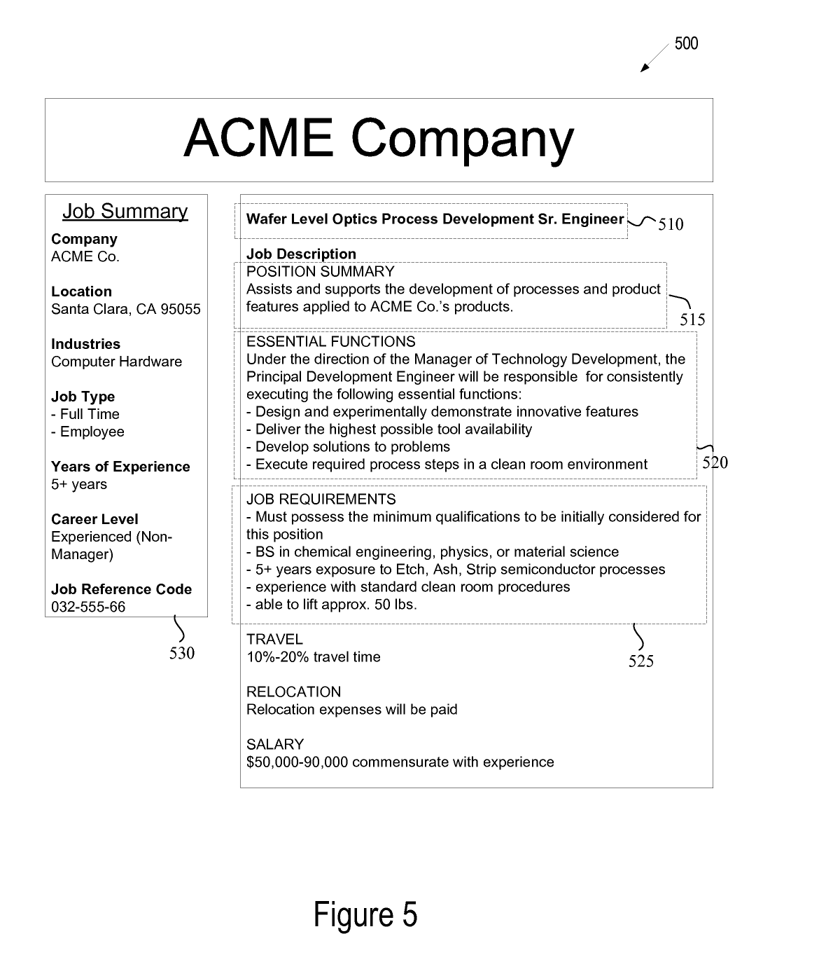

FIG. 5 illustrates an example job posting 500 before it has been reformatted, in accordance with one embodiment of the present invention. As shown, the example job posting 500 includes a job summary section 530, a title 510, a job description summary 515, an essential functions/duties section 520 and a job requirements section 525. Job posting reformatter 218 may scan the job posting for section headings such as “Job Summary,” “Position Summary,” “Essential Functions,” and so on. Job posting reformatter 218 may also scan for keywords such as “salary,” “years,” “education,” and so forth.

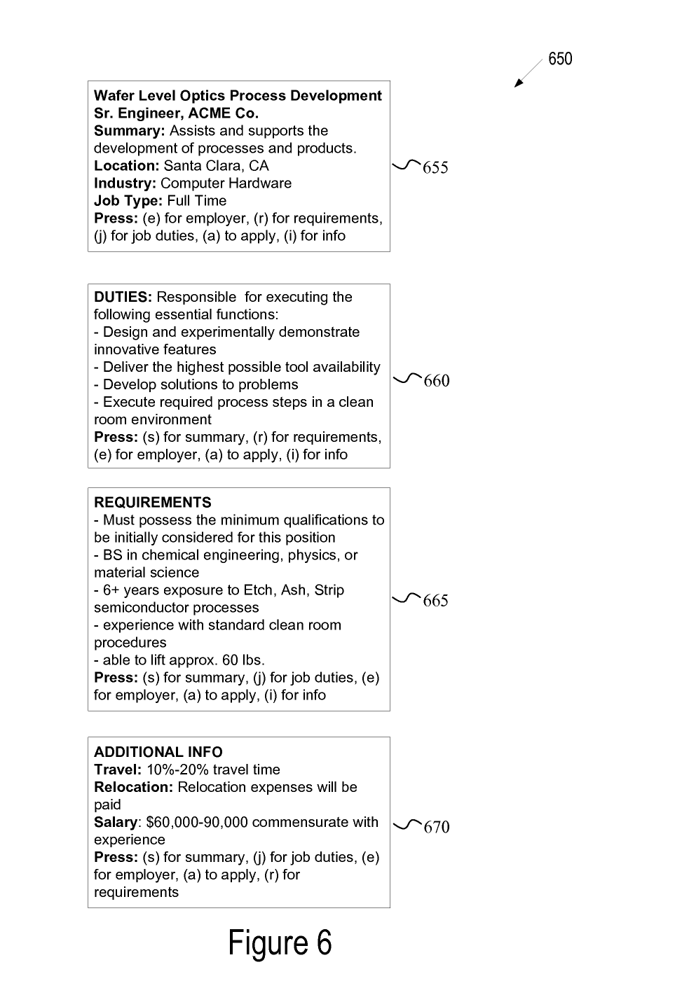

FIG. 6 illustrates a reformatted job posting 650, in accordance with one embodiment of the present invention. As shown, the job posting 500 of FIG. 5 has been reformatted into four portions based on topic. Each portion may comprise one or more pages (e.g., a series of 160 character pages for SMS). When the job posting 650 is sent to a mobile device of a user, the summary portion 655, which may include one or more summary pages, is first sent to the user. The user may then interact with the summary portion 655 (e.g., by pressing “e”, “r,” “j,” “a,” “d,” or “i” on their mobile device) to decline the job posting, apply for the job posting or request additional information. In one embodiment, the user may press “j” to receive a duties portion 660, “r” to receive a requirements portion 665, or “i” to receive an additional information portion 670. At any time while a user is reviewing a job posting, the user may decline the job posting by pressing “d” or may apply to the job posting by pressing “a.”

Returning to FIG. 2, in one embodiment, job posting reformatter 218 automatically generates a qualification survey for a received job posting. To generate the qualification survey, job posting reformatter 218 may scan the job posting for requirements. This may include scanning for key words and/or phrases. For example, job posting reformatter 218 may scan for educational requirements, industry experience requirements, certification requirements, and so forth. Job posting reformatter 218 may generate a separate qualification question for each identified requirement in the job posting. This may include generating the question and each possible answer for the question. Depending on the requirement, job posting reformatter 218 may generate a yes/no question or a multiple choice question. Job posting reformatter 218 may then assign scores to each possible answer to the qualification question. Surveys are discussed in greater detail below. Additionally, an example of a qualification survey that may be automatically generated by job posting reformatter 218 is shown in FIG. 6 and described below.

Referring back to FIG. 2, job posting ranker 222 performs job searches for users and ranks the job search results. Job posting ranker 222 may search job postings 266 that are stored in data store 250. Alternatively, or in addition, job posting ranker 218 may search for job postings by accessing one or more job listing systems. Job posting ranker 222 may periodically perform a separate job search for each user. Alternatively, job posting ranker 222 may perform one or more job searches that applies to multiple users who have requested similar searches. To perform a job search, job posting ranker 222 may access a user's profile 268 and search for job postings that match criteria included in the user profile 268. In one embodiment, job posting ranker 222 performs a job search for a user upon receiving a job search request. Alternatively, job posting ranker 222 may periodically perform job searches for the user, and results of those job searches may be pushed to the user without receiving any user request.

Job posting ranker 222 may rank the job postings that match the search criteria. Job postings may be ranked through qualitative (social graphing, etc.) and quantitative (tags, user-defined preferences, etc) recommendation engines. Job postings may be ranked on user specified criteria, such as distance from a given location (e.g., the user's home), salary, key words, etc. Job postings may also be ranked based on time since the job postings were posted, travel requirements, relocation provisions, etc. In one embodiment, multiple criteria are used to rank the job postings. Once job postings are ranked for the user, the posting rankings 272 may be stored in data store 250.

In one embodiment, ranking is performed by an algorithm that weights the end-user's location and employment preferences against a physical address of a job posting so as to determine distance, the keyword match between the job description and the end-user's job search preferences, and/or the end-users's social graph as acquired from the user's social network accounts. These inputs may produce a personal job posting recommendation for each end-user. A major data parameter that can be analyzed, correlated, and set by administrators is the geographic distance of a job seeker from a particular job opening, thus allowing job seekers to find local jobs in a more efficient, personalized manner. In many instances, the distance set by the job seeker determines the strength of the match between the job and their professional interests.

In one embodiment, job postings are ranked based on user information that has been retrieved from the user's social network account or accounts. In one embodiment, job postings are ranked based on a number of contacts the user has who work for employers associated with job postings. The more contacts of a user who work for an employer, the higher the job posting associated with that employer will be ranked.

User queue manager 216 manages user queues 264. Each user queue 264 is a queue of messages to be sent to the user. The messages in the queue 264 may include the most relevant job postings for an associated user, messages from employers to the user, survey questions, alerts, and other types of messages. One type of message that may be sent to a user is an organization request. An organization request may be a request for a user to “follow” a particular employer. A user who “follows” an employer may receive updates, messages and new job postings from the followed employer before content is received from other employers. Therefore, when a user follows a particular employer, that employer's job postings may be ranked higher than job postings of other employers. User queue manager 216 may manage organization requests to end-users by batching requests and placing them in user queues 264 of appropriate end-users based on their preferences. In the case that these end-users are direct organizational contacts, these messages may be given priority and directly queued to the front of a user queue 264.

Once job posting ranker 222 ranks job postings for a user, user queue manager 216 may add the ranked job postings to that user's user queue 264. The user queue 264 may hold up to a threshold number of messages. In one embodiment, user queue manager 216 adds up to the threshold number of ranked job postings to the user queue. The job postings may be placed into the user queue based on rank, with the highest ranked job posting being placed at the front of the user queue.

In one embodiment, user queue manager 216 updates the user queue 264 each time a job search is performed for a user. If a new job search reveals new job postings that are assigned a higher rank than job postings in the user queue 264, then those existing job postings in the user queue 264 may be demoted in the queue or removed from the queue entirely. User queue manager 216 may also add and remove job postings to/from the user queue 264 based on user input.

User queue manager 216 sends job postings and other messages to mobile devices of users via messaging gateway 206, which is described below. In one embodiment, each job posting, survey, request, etc. is delivered to mobile devices of users in discrete, asynchronous messages. Accordingly, user queue manager 216 may coordinate individual requests and responses to and from mobile devices of users. In one embodiment, the user queue manager 216 keeps track of what a user is replying to currently and sends only one job posting or survey at a time. Each job posting or survey may be associated with a session. A next job posting or survey may not be sent to the user's mobile device until a current session is terminated. The user queue manager 216 may send out scheduled messages and cancel user sessions as necessary. Once user queue manager 216 determines that a new campaign (e.g., a new job posting or survey) is to be sent out, messaging gateway 206 delivers the messages over SMS, voice, Instant Message, etc.

As mentioned, user queue manager 216 may send job postings to users one at a time. User queue manager 216 may send a first job posting in a user queue 264 to the user. User queue manager 216 may then receive a response from the user asking for additional details about the job posting, declining the job posting, or applying to the job postings. If a command to decline the job posting is received, or no response is received from the user in a predetermined amount of time, then it is determined that the user is not interested in the job posting. That job posting is removed from the user queue 264, and the next job posting (or other message) in the user queue is moved to the front of the queue. Additionally, a next highest ranked job posting from the ranked job postings 272 may be added to the end of the user queue 264.

If user queue manager 216 receives a request from a user to apply to a job posting, user queue manager 216 notifies survey manager 210, which may initiate a qualification survey for the job posting. Survey manager 210 manages the delivery of surveys to users. One type of survey is a qualification survey that may be used to determine whether a user meets some minimum requirements for a job posting. However, any type of survey may be delivered to users. For example, survey manager 210 may conduct surveys for political races, product satisfaction, demographics, etc.

In one embodiment, survey manager 210 includes a questioning module 238 and a validating module 234. Questioning module 238 determines survey questions (e.g., qualification questions) to send to a user and then sends the questions to user queue manager 216 for placement at the front of the user queue 264. In one embodiment, when a user begins a survey, questioning module 238 has one or more of the survey questions placed at a front of the user queue 264 for that user. The next survey question in the queue may be sent to the user as each previous survey question is answered.

Questioning module 238 may associate answers to survey questions with different scores. In one embodiment, questioning module 238 scores responses to survey questions when the answers are received. Questioning module 238 may then determine a subsequent survey question or questions to send to the user based on the response to a previous survey question or questions. As the user responds to survey questions, questioning module 238 may have survey questions removed from the user queue 264 and/or added to the user queue 264.

The specific qualifications desired by an employer for a job posting can be defined as individual qualification questions. These questions may be multiple choice, yes/no and/or open ended questions. Each qualification question may include one or more possible answers. For example, a solar panel installation company may want to know how many years of experience a job seeker has, and rate their response according to the employer's needs. In this instance, a response of “0-1 years” by the job seeker may give a weight of “0” to the question, indicating they are not highly qualified for the role. Alternatively, a job seeker could reply “2-4 years” and receive a weight of “1”, indicating they are more qualified. To the extent the user provides a non-uniform response, the questioning module 238 may conduct error checking and ask the user the same question again.

In one embodiment, surveys are generated with a specified questioning order. Questions may be linked with other questions via a branching logic, so that next survey questions are asked based on a user's responses to previous survey questions. Some answers may cause the survey to terminate before all questions have been asked. Other answers may cause some subsequent survey questions to be skipped.

In one embodiment, questioning module 238 checks a user profile 264 before sending a survey question to a user. The user profile 264 may include user responses to previous survey questions asked in other surveys. If an answer to a current survey question is stored in the user's user profile 264, then questioning module 238 may automatically answer the survey question for the user without sending the survey question to the user's mobile device. Therefore, only a partial subset of the questions in a survey may actually be sent to the user in some cases.

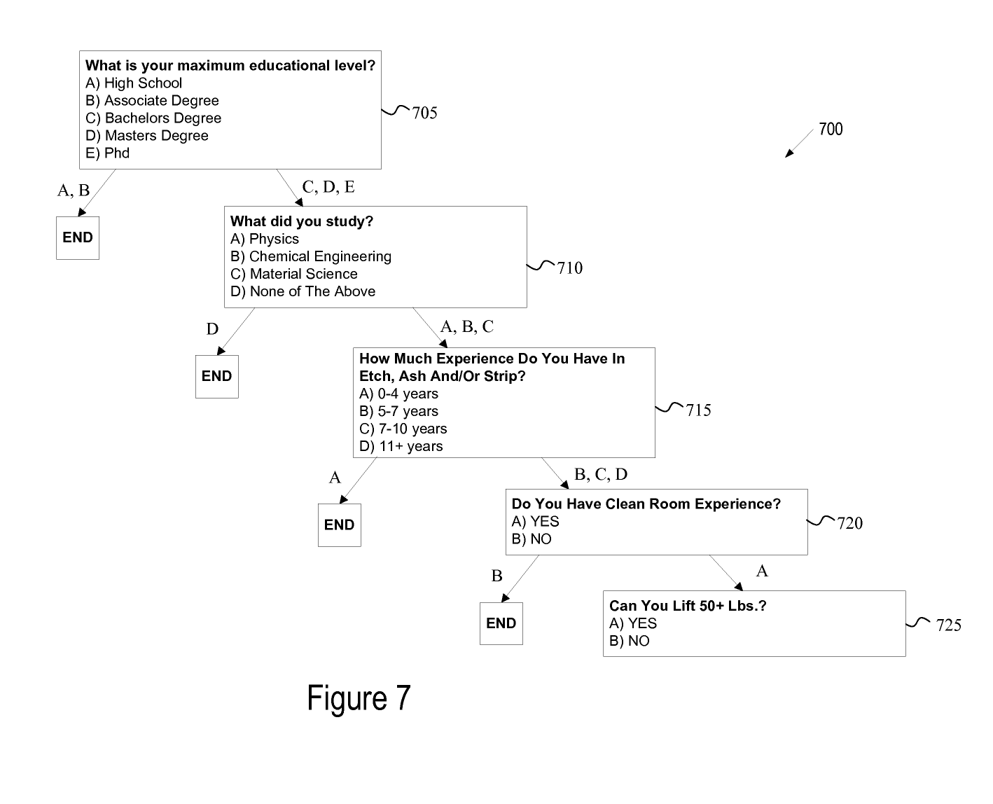

FIG. 7 illustrates an example survey 700 that has been generated for the job posting 500 of FIG. 5, in accordance with one embodiment of the present invention. The survey 700 may have been provided by an employer. Alternatively, job posting reformatter 218 may have automatically generated the survey based on a retrieved job posting, as described above. As shown, the survey 700 includes multiple choice questions 705, 710 and 715 and yes/no questions 720, 725 that are relevant to an associated job posting. The survey questions are linked, so that a subsequent survey question is sent to a user based on the user's response to a previous survey question. If a user answers any of the survey questions with a response that indicates the user is unqualified for the job posting, then the survey may be terminated.

Referring back to FIG. 2, in one embodiment, validating module 234 validates a job seeker's responses to a qualification survey associated with a job posting. The job seeker's responses may be validated by sending the same survey to a reference or references specified by the job seeker. The reference may be asked to answer the qualification questions as they apply to the job seeker. For example, the reference may be asked how many years of experience the job seeker has, the job seeker's educational background, and so on. Questioning module 238 may therefore conduct the same survey with a reference of the user. Once the survey is complete, validating module 234 compares the user's answers to the qualification questions to the reference's answers to the qualification questions. If the answers match, then validating module 234 determines that the user truthfully answered the qualification questions, and validates the user's responses. If the answers fail to match, then validating module 234 may determine that the user's responses to the qualification questions are questionable. Note that in response to each qualification question sent to the reference, the reference may reply with an “unknown or do not wish to disclose” answer, in addition to the answers that were available to the user. If one or some of the reference's answers were unknown or not disclosed, then validating module 234 may determine that validation was inconclusive.

A user's responses to one or more qualification questions in a qualification survey may indicate that the user lacks a specific prerequisite for a particular job posting or job postings. In one embodiment, advancement manager 212 analyzes a user's survey responses to determine if the user failed to qualify for a job posting due to lack of any prerequisites. Advancement manager 212 may analyze the responses to multiple qualification surveys associated with multiple different job postings to make such an assessment. For example, advancement manager 212 may identify that a user answered that he does not have a drivers license, which may have been a qualification question in multiple jobs that the user applied for. Advancement manager 212 may also receive information from an employer indicating weaknesses of the user. Additionally, other information may be used to identify experience and/or training that will be valuable to the user for future employment.

Advancement opportunity search module 240 searches systems such as web servers for universities, adult education schools, certifying agencies, volunteer organizations, training organizations, trade schools, community colleges, and so forth to find advancement opportunities. Advancement opportunity search module 240 may perform searches to identify advancement opportunities for a user that will help the user in future job applications. In one embodiment, advancement opportunity search module 240 searches for advancement opportunities that will give the user the experience, training, certificate, etc. that was a prerequisite for the one or more job postings that the user applied to. Advancement opportunity ranking module 242 then ranks those advancement opportunities for the user. The advancement opportunities may be ranked based on starting date (e.g., sooner starting dates may be given a higher rank), location (e.g., advancement opportunities that are closest to the user may be given a higher rank) and value. A higher value may be assigned to those advancement opportunities that are more likely to help the user to satisfy the prerequisites in question. For example, if the prerequisite is certification for installing solar panels, then a certification class may be associated with a high value, and a volunteer opportunity that will give the user expose to installing solar panels but that does not actually provide the certification may be given a low value. In the case that there are multiple opportunities that are equally valued for the individual user, the larger response set is taken into account, such that a user's greatest weakness is identified in contrast to the competency that is most satisfied by other users (i.e., if everyone else already has a certain degree, and the user is lacking this degree, it becomes the higher priority opportunity to recommend to them, even if they scored equally poorly on educational and years of experience questions).

Advancement manager 212 may send a highest ranked advancement opportunity or opportunities to user queue manager 216 for placement in the user queue 264. The advancement opportunity may be formatted for presentation on a mobile device (e.g., on a mobile phone) in a similar manner as described above with reference to job postings 266. The user may then respond by requesting more information, by initiating an enrollment process, by calling the organization providing the advancement opportunity, or by taking some other action.

Job search manager 202 may conduct job searches, send job postings and receive job applications from many users. Similarly survey manager 210 may receive completed surveys (including job qualification surveys and other surveys) from multiple users. Results manager 214 analyzes the job applications and survey responses of multiple users, and then generates results. This may include calculating statistics and trends about the job posting across users, geographies, and other time-based or location-based data sets.

In one embodiment, results manager 214 includes a trend analyzer 274 that analyzes and compiles statistics on response data, application data, reviews, etc. for a particular job or employer. Trend analyzer 274 may generate real-time graphs that show trends amongst communities of job seekers. In one embodiment, trend analyzer 274 captures encoded, contextual data included in users' qualitative responses to multiple choice, yes/no, and other open-ended survey questions, and combines these data sets to generate trends (e.g., location-based trends). By interpreting parametric pairings of a job seeker's factual and contextual data sets, trend analyzer 274 can generate real-time data of user behaviors, trends, and locations that can better inform job matching and placement. Trend analyzer 274 may also identify the time between when job seekers first receive targeted job alerts, and when they respond to these alerts. This time between responses can be used to quantify how motivated a job seeker is in relation to a particular job.

In one embodiment, trend analyzer 274 exposes behavioral biases for particular jobs or employers. By responding to particular employment opportunities and rejecting other employment opportunities, the user will both register their interest and lack of interest in particular jobs. Additionally, users may post user reviews of particular employers and/or job postings. Respected employers may be rewarded with positive public reviews, whereas poorly received employers or jobs may be negatively reviewed. A full history of job applications and inquiries can be kept by the system, and can be used for statistical purposes.

In one embodiment, trend analyzer 274 measures job seeker demand for a job posting based on natural language responses to automated questions sent to users' mobile devices (e.g., via SMS text message). Trend analyzer 274 can quickly and quantitatively measure community demand for jobs, and in doing so, identify trends particular to positions and populations of users. The trend analysis information could be used by a job placement firm to assess the risk of working with a particular employer, or to determine the desirability of a particular job. This information could alternatively be used to inform an employer of their chances of finding the right candidate, or to identify skill gaps between the employer's request and the job seekers responses.

In one embodiment, the trend analysis information is used to set a placement service fee that correlates with job seeker demand for a job posting. Where demand is high, the service fee may be lower because the chances of finding the right candidate are increased. Where demand is weak, the service fee may be set higher because the chances of finding the right candidate are decreased. This effectively creates a “market-rate” for each job placement. Currently, job placement services cannot price their service based on job seeker demand or trends. Instead, they rely on industry standard fee arrangements. With more information available to a job placement firm, they could better price their services and more efficiently connect job seekers with jobs.

In one embodiment, results manager 214 includes a candidate ranking module 246. Candidate ranking module 246 ranks all candidates (job seekers) for a particular job posting. Candidates may be ranked based on answers to qualification questions in a qualification survey, based on application timeliness, based on information from users' social network accounts, and/or based on other information. Candidate ranking module 246 generates a candidate ranking pool 262 for each job posting. Thus, candidate ranking module 246 can weight responses to questions to identify the most qualified job seekers for a particular position.

In one embodiment, results manager 214 includes a reporting module 248. Reporting module 248 reports candidate ranking pool to employers. Candidate reporting module 248 may also report the trend data to employers and/or job seekers. Some information in the trend data and/or candidate ranking pool may be anonymized before being sent to employers or job seekers.

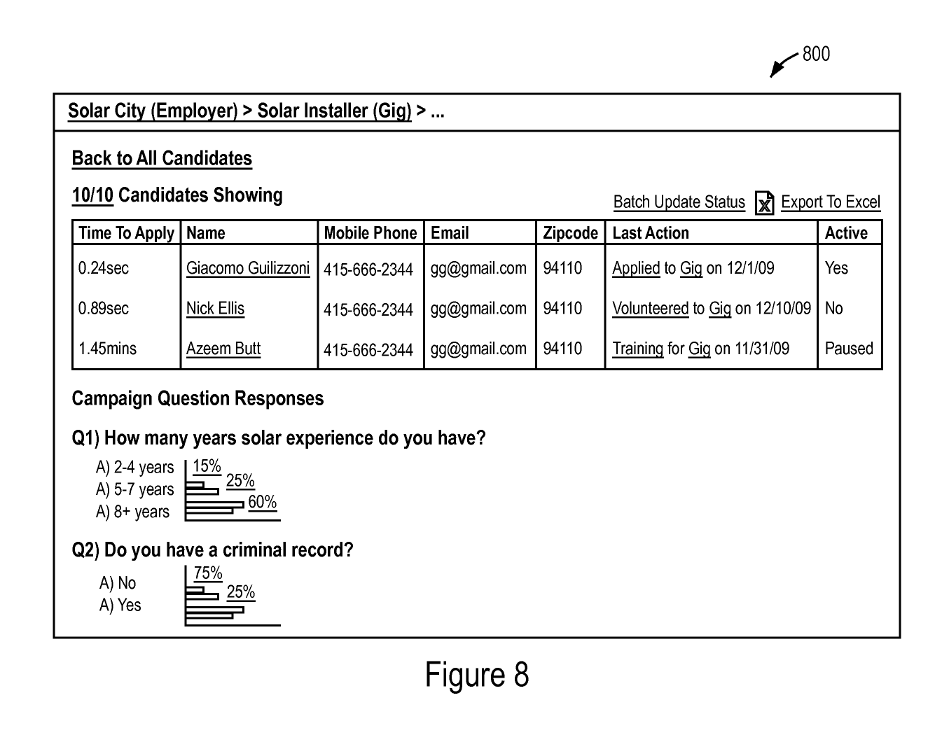

FIG. 8 illustrates trend data 800 for a particular job posting, in accordance with one embodiment of the present invention. The trend data 800 shows real-time trends based on user responses to the job posting. As user responses are gathered for particular qualification questions of a qualification survey associated with the job posting, the responses are parsed and weighted, and trend analyzer 234 generates dynamic data sets that identify important job seeker trends. The trend data can be viewed both online and on users' mobile devices in a visual or text format.

Trend data 800 includes applicant information, including when applicants applied to the job posting, applicant names, applicant phone numbers, applicant locations (e.g., zip codes), etc. Note that some or all of this information may be anonymized. Trend data 800 may also show the survey questions associated with the job posting. For each survey question, trend data 800 shows the percentage of applicants that provided each possible answer. For example, for question 1, 15% of applicants answered that they have 2-4 years of solar experience, 25% of applicants answered that they have 5-7 years of solar experience, and 60% of applicants answered that they have 8+ years of solar experience.

Returning to FIG. 2, messaging gateway 206 interfaces with mobile devices. In one embodiment, the messaging gateway 206 includes a separate module for each type of messaging protocol supported by messaging gateway 206. Via the modules, messaging gateway 206 may send job postings, surveys, alerts and other messages to mobile devices. Messaging gateway 206 may also receive responses to the job postings, surveys etc. from the mobile devices via the appropriate modules. In one embodiment, messaging gateway 206 includes an SMS module for communicating with mobile devices using SMS, an instant messaging module for communicating with mobile devices via one or more instant messaging protocols (e.g., ICQ, AIM, etc.), and an email module 258 for communicating with mobile devices via email. In one embodiment, messaging gateway 206 includes a voice module 258. Voice module 256 provides a computerized voice driven menu system that informs the user about jobs and enables the user to apply to jobs and/or answer survey questions. In one embodiment, messaging gateway 206 includes a mobile application module 260 that communicates with mobile job modules installed on mobile devices (e.g., a mobile job application installed on a smart phone). Messaging gateway 206 may determine how to deliver the messages to the mobile devices based on individual user preferences and/or capabilities of the mobile devices.

Mobile job server 200 is capable of sending messages to mobile devices of a user using both a “push” and “pull” model. Mobile job server 200 can “push” employment information to multiple job seekers simultaneously, instead of waiting for job seekers to request or “pull” that same information. Therefore, the mobile job server 200 does not require the job seeker to actively be searching for a job to receive employment information. Additionally, mobile job server 200 can wait for job seekers to request or “pull” information.

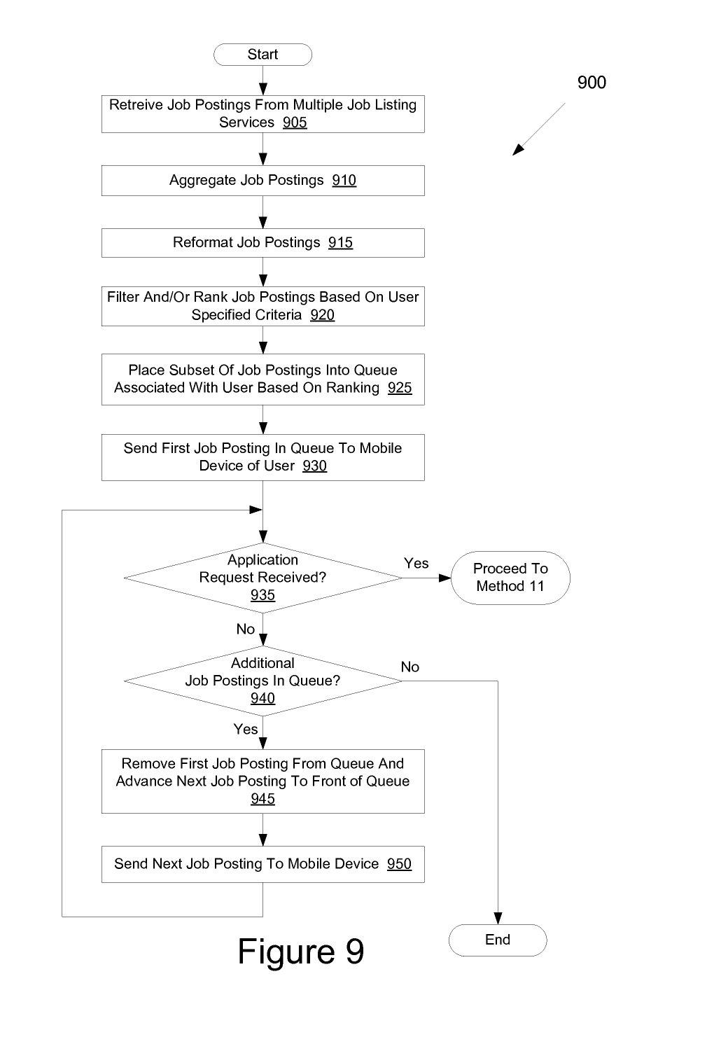

FIG. 9 is a flow diagram of one embodiment for a method 900 of sending job postings to mobile devices. The method is performed by processing logic that may comprise hardware (circuitry, dedicated logic, etc.), software (such as is run on a general purpose computer system or a dedicated machine), or a combination of both. In one embodiment, method 900 is performed by processing logic 175 of mobile job system 102 shown in FIG. 1.

Referring to FIG. 9, at block 905 of method 900 processing logic 175 retrieves job postings from multiple job listing services. Job postings may be retrieved using provided APIs that give access to databases of job listing services, by subscribing to RSS feeds, Atom feeds, XML feeds or other subscription feeds, or by other techniques. At block 910, processing logic 175 aggregates the job postings. At block 915, processing logic 175 reformats the job postings. Reformatting a job posting may include parsing the job posting and dividing the parsed job posting into multiple portions. Each portion may include one or more pages that are viewable on a small display of a mobile device. In one embodiment, each portion is divided into one or more 160 character pages that may be transmitted using SMS.

At block 920, processing logic 175 filters and/or ranks the job postings for a user based on user specified criteria. The user specified criteria may include a specified industry, salary range, location, key words, etc. In one embodiment, end-users may register for specific information (e.g., alerts, surveys, job postings, etc.) from their mobile phone. In one embodiment, job postings are ranked on information obtained from a user's social network accounts (e.g., based on a user's contact information).

At block 925, processing logic 175 places a subset of the ranked job postings into a queue associated with the user. At block 930, processing logic 175 sends a first job posting in the queue to the user. In one embodiment, processing logic 175 “pushes” out job alerts and other professional development information pertinent to the end-user based on their specific preferences.

At block 935, processing logic 175 determines whether an application request has been received for the job posting that was sent to the user. If no application request or other user response is received for a specified amount of time, the job notification may be resent to the user. If an application request is received for the job posting, the method ends and method 1100 begins, and processing logic 175 will exchange employer-defined questions and answers with the end-user in order to qualify them for the position. If no application request is received (e.g., if the user ignores the job notification or sends a message stating that he is not interested in the provided job posting), the method continues to block 940.

At block 940, processing logic 175 determines whether there are any more job postings in the user queue. If there are additional job postings, then the method proceeds to block 945. If there are not additional job postings, the method ends.

At block 945, processing logic 175 removes the first job posting from the user queue and advances a next job posting to the front of the queue. At block 950, processing logic 175 sends the next job posting to the mobile device of the user. Note that at block 940, processing logic 175 may also determine whether there are any other types of messages in the queue, such as surveys. The other types of messages may also be advanced in the queue and sent to the mobile device of the user.

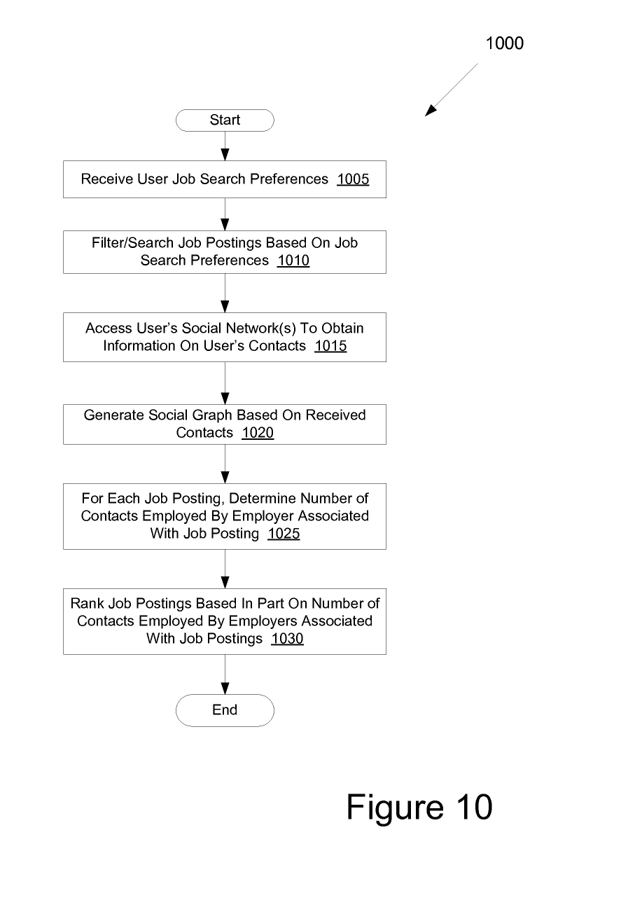

FIG. 10 is a flow diagram of one embodiment for a method 1000 of ranking job postings. The method is performed by processing logic that may comprise hardware (circuitry, dedicated logic, etc.), software (such as is run on a general purpose computer system or a dedicated machine), or a combination of both. In one embodiment, method 1000 is performed by processing logic 175 of mobile job system 102 shown in FIG. 1.

Referring to FIG. 10, at block 1005 of method 1000 processing logic 175 receives user job search preferences. The user job search preferences may include location preferences, may designate a home location and distance preferences, may include salary preferences, may include industry preferences, and so forth. At block 1010, processing logic 175 searches for and/or filters multiple job postings based on the job search preferences.

At block 1015, processing logic 175 accesses a user's social network (or multiple social networks) to obtain information about the user's contacts. The obtained information may include current and past employment information for the user's contacts. At block 1020, processing logic 175 generates a social graph based on the received contacts of the user. The social graph may include contacts from multiple different social network accounts of the user. For example, the social graph may include contacts from a LinkedIn account and from a Facebook account. If multiple social network accounts of the user include the same contact, then information from those different accounts for that contact may be combined into a single entry on the social graph. Conflicts may be resolved by using the most recent data.

At block 1025, for each job posting identified at block 1010, processing logic 175 determines a number of contacts in the social graph that are employed by the employer associated with that job posting. At block 1030, processing logic 175 then ranks the job postings based on the number of contacts employed by employers associated with the job postings. Note that this may be just one ranking criterion. In addition or instead of the contact employment information, salary information, distance information, etc. may also be used to rank the job postings.

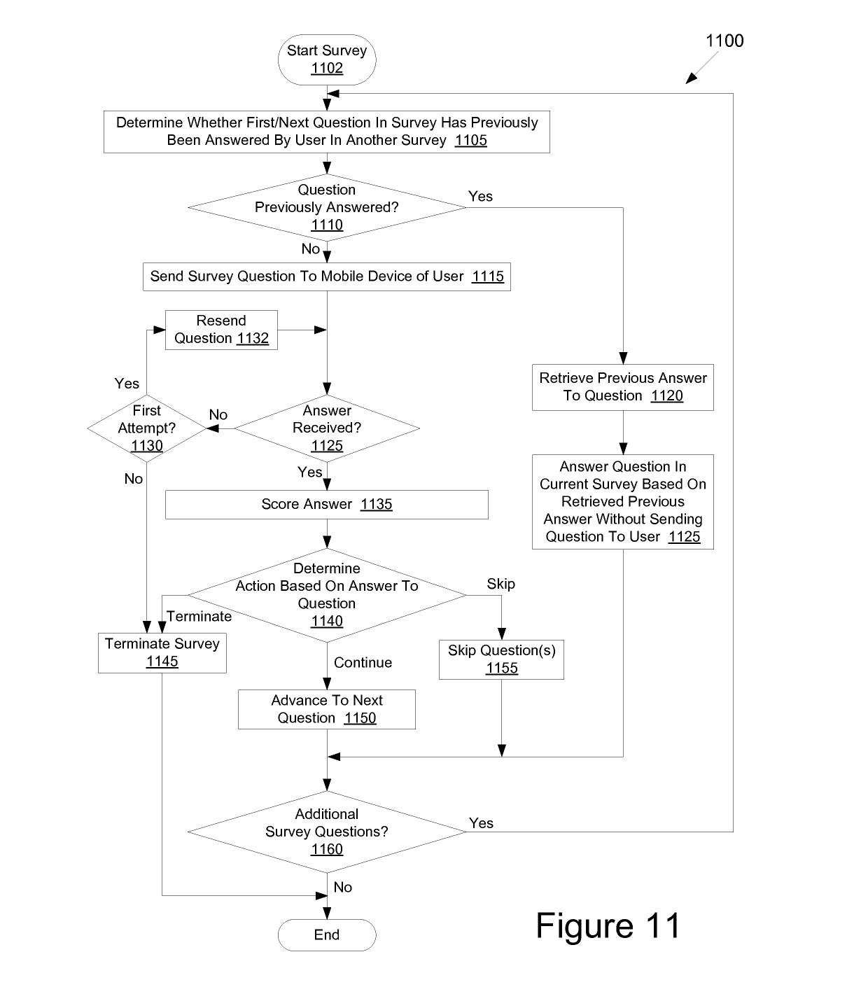

FIG. 11 is a flow diagram of one embodiment for a method 1100 of conducting surveys using mobile devices. The method is performed by processing logic that may comprise hardware (circuitry, dedicated logic, etc.), software (such as is run on a general purpose computer system or a dedicated machine), or a combination of both. In one embodiment, method 1100 is performed by processing logic 175 of mobile job system 102 shown in FIG. 1.

Referring to FIG. 11, at block 1102 of method 1100 processing logic 175 begins a survey. The survey may be a qualification survey started in response to a user request to apply for a job. Alternatively, the survey may be some other type of survey, such as an opinion poll. Once the survey is started, processing logic 175 will deliver a set of pre-defined questions/responses to end-users based on their specific responses. For example, if a user registers by sending a text message containing the keyword “BTC” (Bridge to College) to a telephone number (shortcode or longcode) so that they can register to take summer school courses to get better prepared for a four-year university, the processing logic 175 may immediately respond with a set of pre-defined registration questions particular to that user associated with registration. Questions could include identifying specific school courses of interest for the end-user, times they are available to attend class, and basic demographic data.

In one embodiment, at block 1105, processing logic 175 determines whether a first question in the survey has previously been answered by the user in another survey. For example, many job qualification surveys may ask the user his maximum education achieved. If the first survey question was previously answered, the method continues to block 1120. If the first survey question was not previously answered, the method continues to block 1115. Note that in jurisdictions where such functionality is prohibited by law, block 1105 is skipped.

The user need only answer a survey question once. When the user answers a survey question, that answer may be stored in a user profile. Therefore, at block 1120, processing logic 175 retrieves the previous answer to the survey question from the user profile. At block 1125, processing logic 175 then answers the question based on the retrieved previous answer without sending the survey question to the user. The method then continues to block 1160.

At block 1115, processing logic 175 sends the first survey question to the mobile device of the user. In one embodiment, the survey question is sent to the mobile device of the user via SMS. Each of these survey questions may be formatted to be wholly displayed within the mobile device's screen (e.g., within an SMS interface). The survey questions may include menu options that allow further interaction.

At block 1125, processing logic 175 determines whether an answer to the survey question has been received from the user's mobile device. If no answer has been received for a certain amount of time (e.g., 60 minutes), the method continues to block 1130. If a response is received, the method continues to block 1135.

At block 1130, processing logic 175 determines whether the survey question has been resent to the user. If the survey question has only been sent to the user once, then the method continues to block 1132 and the question is resent to the user. If the survey question has already been sent to the user's mobile device multiple times, the method continue to block 1145 and the survey is terminated. This may include marking a current user session as incomplete and cancelling the user session.

At block 1135, processing logic 175 scores the answer to the survey question. Each question may be associated with a scoring key that identifies what scores to assign to each of the possible answers for that survey question. The score allows an employer to identify different tranches of qualified job seekers (e.g., from most qualified to least qualified).

At block 1140, processing logic 175 determines a subsequent action to take based on the answer to the last question or questions. The survey may include branching logic that branches the end-user to a different set of questions based on their responses. In doing so, the processing logic 175 may dynamically update a back-end database to correlate distinctly different, qualitative data into a quantitative framework. Possible actions include terminating the survey (block 1145), continuing to a specified next question (block 1150) and skipping to a later subsequent question (block 1155). At block 1160, processing logic 175 determines whether there are any additional questions to ask of the user. If there are any additional survey questions, the method returns to block 1105. Otherwise, the method ends.

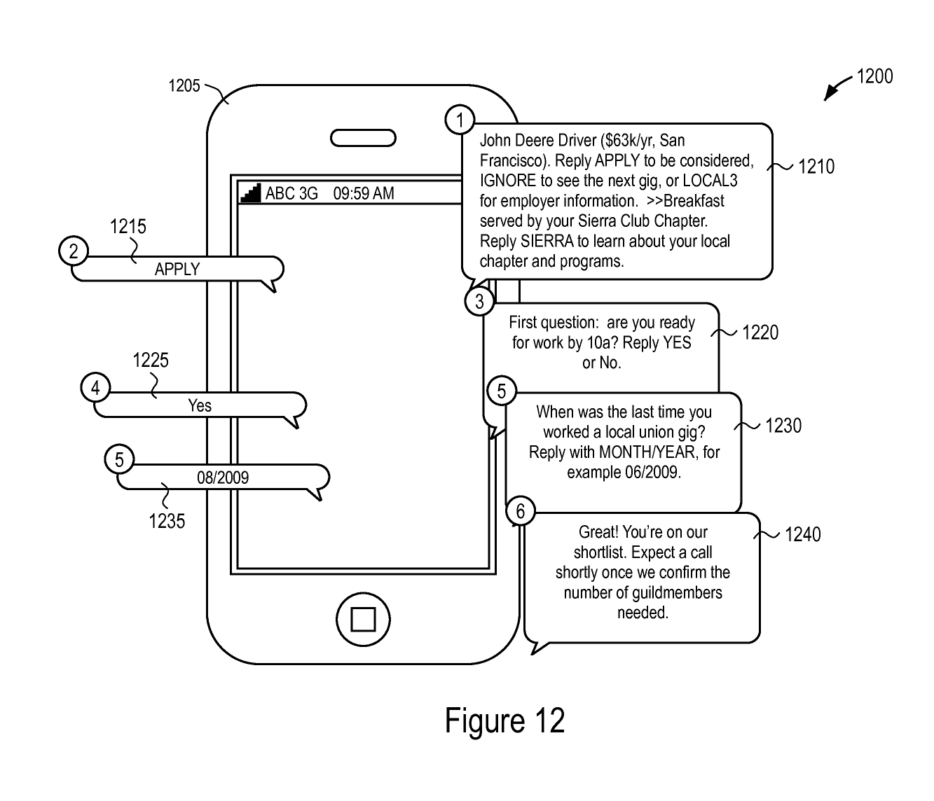

FIG. 12 illustrates a block diagram 1200 showing a user session associated with a particular job position, in accordance with one embodiment of the present invention. The user session includes a series of messages and responses sent back and forth between a mobile phone 1205 of the user and a mobile job server. The session begins with mobile phone 1205 receiving an alert for a new job posting (block 1210). The job posting may be the highest ranked job posting in the user's queue. The user then applies to the job at block 1215. A qualification survey for the job posting is then started, and at block 1220 a first qualification question is sent to the mobile phone 1205. At block 1225, the user answers YES to the first qualification question. A second qualification question is then sent to the user at block 1230. At block 1235, the user answers the second qualification question. The survey is then completed, and the mobile device 1205 receives an application confirmation message at block 1240.

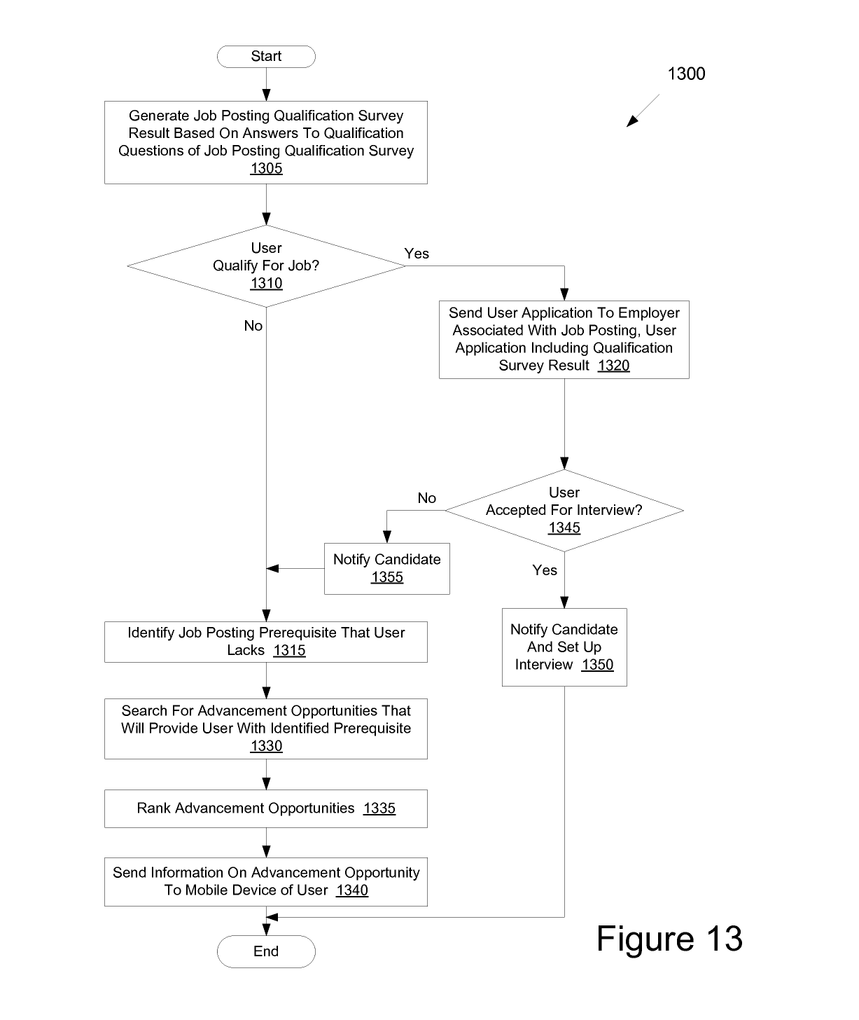

FIG. 13 is a flow diagram of one embodiment for a method 1300 of helping a job applicant improve his/her qualifications for job postings. The method is performed by processing logic that may comprise hardware (circuitry, dedicated logic, etc.), software (such as is run on a general purpose computer system or a dedicated machine), or a combination of both. In one embodiment, method 1300 is performed by processing logic 175 of mobile job system 102 shown in FIG. 1.

Referring to FIG. 13, at block 1305 of method 1300 processing logic 175 generates a job posting qualification survey result based on answers to one or more qualification questions of a job posting qualification survey. At block 1310, processing logic 175 determines whether a user qualifies for the job based on the results. If the user qualifies for the job (e.g., meets are requirements or prerequisites for the job), the method continues to block 1320. If the user fails to qualify for the job, the method continues to block 1315.

At block 1320, processing logic 175 sends the user application to an employer associated with the job posting. Sending the application to the employer may include sending a qualification survey results to the employer. Additionally, sending the application may include sending a previously uploaded resume of the user to the employer. In one embodiment, processing logic 175 sends an email that includes a profile of the user with an attached resume to the employer. In another embodiment, processing logic 175 adds the user directly to an applicant tracking system pipeline of the employer.

Once the application is sent to the employer, the employer may either accept the applicant and move them to an interview, or reject the applicant. At block 1345, processing logic 175 determines whether the applicant has been accepted or rejected for an interview. If the user is accepted for an interview, the method continues to block 1350. Otherwise, the method continues to block 1355.

At block 1350, processing logic 175 notifies the candidate that he has been selected for an interview and proposes a set of interview times that are available on the employer's calendar (the service integrates with existing calendar solutions such as Google Calendar®, Microsoft Outlook®, etc) for an interview. Once the job seeker specifies a time they are available for interview, processing logic 175 may confirm the time, send a reminder before the actual interview, and then initiate the interview with calls to the employer and job seeker, who may be immediately connected via voice/video. In one embodiment, a keyword is either dynamically generated or user-defined for an appointment request. The keyword may be a unique and temporary value that enables the appointment request to be “pulled” by an end-user by sending the assigned keyword to the processing logic. Every appointment request to a particular person may be assigned a unique keyword for access at a later point up until the designated appointment time has passed. Processing logic 175 may additionally perform background checks, perform reference checks, initiate offer negotiation, perform onboarding, etc.

At block 1355, the user is notified that he was not selected for an interview, and the method proceeds to block 1315.

At block 1315, processing logic 175 identifies a job posting prerequisite that the user lacks or qualification that the user lacks. If a candidate is rejected for a position, the platform may identify the greatest skill weakness as it pertains to the employer's criteria and ranking and recommend a local training/volunteer opportunity that allows the job seeker to up-skill themselves. The identified skill weakness may be based on employer feedback as well as an analysis of the candidate's response to a set of questions.

At block 1330, processing logic 175 searches for advancement opportunities that will provide the user with the identified prerequisite or skill When processing logic 175 identifies a response that does not meet an employer criterion (say, for example, an end-user replies that they have “1-2 years experience” and the employer is looking for more 3+ years experience), the platform may store this response and run a keyword query against a database of volunteer and training opportunities that pertain to the skill weakness.

At block 1335, processing logic 175 ranks one or more job opportunity search results. The search results may be ranked based on location (e.g., distance to user), timeliness (e.g., when the opportunity starts) and value. At block 1340, processing logic 175 then sends information on one or more highest ranked advancement opportunities to the user. This skill-based assessment allows job seekers to receive near real-time recommendations that allow them to ‘up-skill’ themselves, eliminating the “black hole” experience that defines existing job application processes. These recommendations may be location-based, and where the job seeker has connected their calendar to the platform, take into account the job seekers availability for various commitments. Throughout this process, the job seeker can request additional, granular, qualitative information on the specific strengths/weaknesses of their application, so as to create a more meaningful career dialogue. This recommendation may take into account historical data by mining previous answers to identify long-term skill trends and map them to career paths that optimize long-term opportunity.

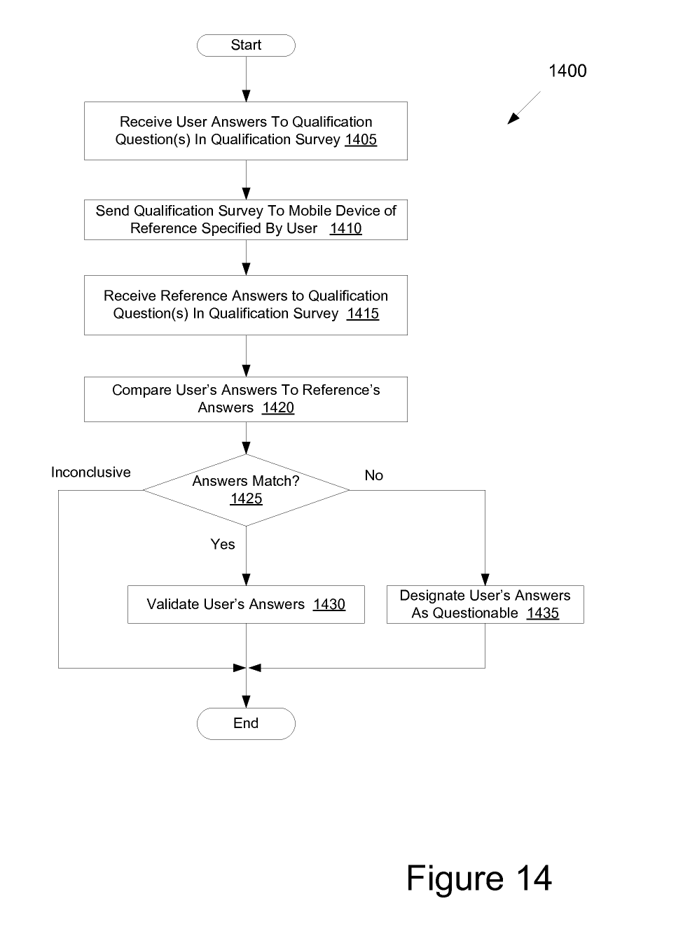

FIG. 14 is a flow diagram of one embodiment of a method 1400 for validating a job seeker's responses to qualification questions in a survey. The method 1400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1400 is performed by processing logic 175 of mobile job system 102 shown in FIG. 1.

At block 1405 of method 1400 processing logic 175 receives user answers to one or more qualification questions in a qualification survey. At block 1410, processing logic 175 identifies a reference of the user, and sends the qualification survey to the identified reference. In one embodiment, the qualification survey is sent to the reference via SMS. The qualification questions may be sent to the reference sequentially, with each subsequent question being sent after receiving a response to a previous qualification question. Each qualification question corresponds to a qualification question that was asked of the user. For example, if the user was asked whether he has a drivers license, then the reference would be asked whether the user has a drivers license.

At block 1415, processing logic 175 receives answers to the qualification questions from the user's reference. At block 1420, processing logic 175 compares the user's answers to the reference's answers. At block 1425, if the answers match, the method continues to block 1430 and the user's answers are validated. If at block 1425 processing logic 175 determines that the answers do not match, then the method continues to block 1435, and processing logic 175 designates the answers as questionable. The reference's answers may also include answers of unknown or prefer not to disclose. In such an instance, at block 1425 processing logic 175 determines that validation is inconclusive. The method then ends.

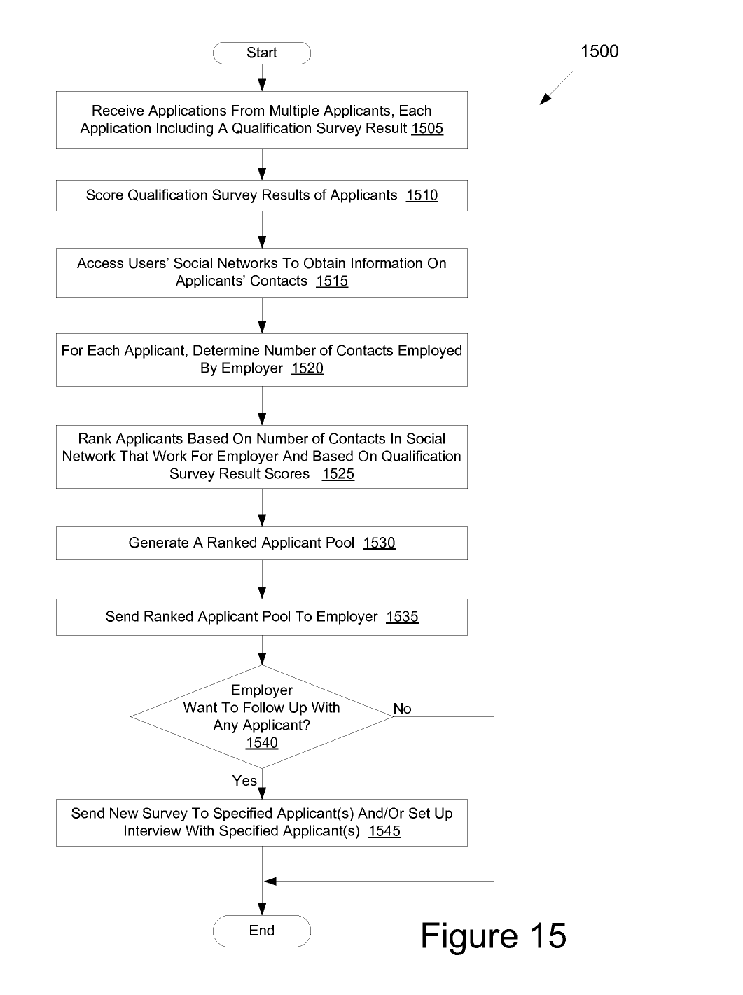

FIG. 15 is a flow diagram of one embodiment of a method 1500 for generating ranked candidate pools. The method 1500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1500 is performed by processing logic 175 of mobile job system 102 shown in FIG. 1.

At block 1505 of method 1500 processing logic 175 receives job applications from multiple applicants. Each job application may include qualification survey results. At block 1510, processing logic 175 scores the qualification survey results. The qualification survey results may be scored using a scoring key. Each answer to a qualification question may be assigned a specific score. An applicant's application may be assigned an overall score based on the answers to all of the qualification questions included in the qualification survey.

At block 1515, processing logic 175 accesses social networks of the applicants to obtain information about the applicants' contacts. At block 1520, processing logic 175 determines, for each applicant, a number of that applicants contacts (from the applicant's social network) that are employed by the employer. At block 1525, processing logic 175 ranks the applicants based on the number of contacts in their social networks that work for the employer and based on their qualification survey result scores.

At block 1530, processing logic 175 generates a ranked applicant pool. The applicants may be ranked into quartiles. At block 1535, processing logic 175 sends the ranked applicant pool to the employer. At block 1540, processing logic 175 determines whether the employer wants to follow up with any of the applicants. If the employer wants to follow up with an applicant or applicants, the method continues to block 1545. Otherwise the method ends.

At block 1545, processing logic 175 receives a new survey and sends the new survey to specified applicants. The new survey may ask additional questions to further distinguish the applicants. Additionally, at block 1545 processing logic 175 may set up interviews with one or more of the specified applicants.

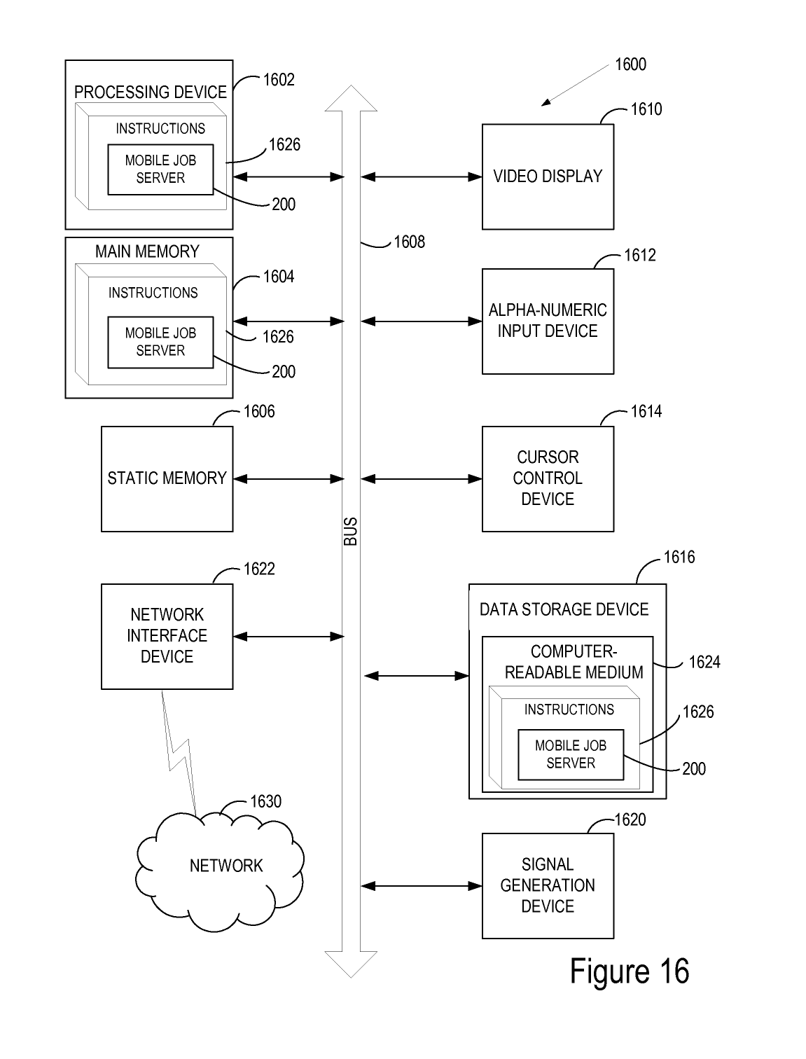

FIG. 16 is a block diagram illustrating an exemplary server computing device 1600. In one embodiment, the server computing device corresponds to mobile job system 102 of FIG. 1. The server computing device 1600 is a machine (or machines) that includes a set of instructions 1626 for causing the machine to perform any one or more of the methodologies discussed herein. The machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary server computing device 1600 includes a processing device 1602, a main memory 1604 (e.g., read-only memory (ROM), flash memory, dynamic random access memory (DRAM) such as synchronous DRAM (SDRAM), etc.), a static memory 1606 (e.g., flash memory, static random access memory (SRAM), etc.), and a data storage device 1616, which communicate with each other via a bus 1608. Each of the processing device 1602, main memory 1604, and/or data storage device 1616 may include instructions 1626. In one embodiment, the instructions 1626 include processing logic 175 of FIG. 1. The instructions 1626 may include instructions for a mobile job server 200. The mobile job server 200 may contain the processing logic 175, or may be included in processing logic 175.

Processing device 1602 represents one or more general-purpose processing devices such as a microprocessor, central processing unit, or the like. More particularly, the processor 1602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 may also be one or more special-purpose processing devices such as an application specific integrated circuit (ASIC), a field programmable gate array (FPGA), a digital signal processor (DSP), network processor, or the like. The processing device 1602 is configured to execute the mobile job server 200 for performing the operations and steps discussed herein.

The computer system 1600 may further include a network interface device 1622. The computer system 1600 also may include a video display unit 1610 (e.g., a liquid crystal display (LCD) or a cathode ray tube (CRT)), an alphanumeric input device 1612 (e.g., a keyboard), a cursor control device 1614 (e.g., a mouse), and a signal generation device 1620 (e.g., a speaker).

The data storage device 1616 may include a computer-readable medium 1624 on which is stored one or more sets of instructions (instructions of mobile job sever 200) embodying any one or more of the methodologies or functions described herein. The mobile job server 200 may also reside, completely or at least partially, within the main memory 1604 and/or within the processing device 1602 during execution thereof by the computer system 1600, the main memory 1604 and the processing device 1602 also constituting computer-readable media.

While the computer-readable storage medium 1624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “aggregating”, “ranking”, “placing”, “sending”, “searching” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
generating job search results for a user;
accessing a social network account of the user to determine employers of contacts in the user's social network;
for each job search result, determining a number of contacts in the user's social network that work for an employer associated with the job search result;
ranking the job search results based at least in part on the number of contacts in the user's social network that work for employers associated with the job search results; and
providing the ranked search results to the user.

2. The method of claim 1, further comprising:
receiving an application for a job posting included in the job search results from the user;
receiving applications for the job posting from a plurality of additional users;
accessing social network accounts of the plurality of additional users to determine employers of contacts in social networks of the plurality of additional users; and
ranking the user and the plurality of additional users based at least in part on number of contacts in the users' social networks that work for an employer associated with the job posting.

3. The method of claim 1, further comprising:
receiving an application for a job posting included in the job search results from the user;
determining that at least one person in the user's social network works for an employer associated with the job posting; and
requesting a referral from the at least one person.

4. The method of claim 1, further comprising:
accessing a plurality of social network accounts for the user to determine employers of contacts in the user's social networks;
for each job search result, determining the number of contacts in the user's social networks that work for the employer associated with the job search result; and
ranking the job search results based at least in part on the number of contacts in the user's social networks that work for employers associated with the job search results.

5. The method of claim 4, further comprising:
combining contacts from the plurality of social network accounts for the user and removing any redundant contacts.

6. The method of claim 1, further comprising:
determining a number of contacts in the user's social network who previously worked for the employer; and
ranking the job search results based at least in part on the number of contacts in the user's social network that previously worked for the employers associated with the job search results.

7. The method of claim 1, wherein providing the ranked search results to the user comprises:
placing a subset of the ranked search results into a queue associated with the user based on the ranking; and
sending a first job search result in the queue to a mobile phone of the user.

8. A computer readable medium including instructions that, when executed by a processing device, cause the processing device to perform a method comprising:
generating job search results for a user;
accessing a social network account of the user to determine employers of contacts in the user's social network;
for each job search result, determining a number of contacts in the user's social network that work for an employer associated with the job search result;
ranking the job search results based at least in part on the number of contacts in the user's social network that work for employers associated with the job search results; and
providing the ranked search results to the user.

9. The computer readable medium of claim 8, the method further comprising:
receiving an application for a job posting included in the job search results from the user;
receiving applications for the job posting from a plurality of additional users;
accessing social network accounts of the plurality of additional users to determine employers of contacts in social networks of the plurality of additional users; and
ranking the user and the plurality of additional users based at least in part on number of contacts in the users' social networks that work for an employer associated with the job posting.

10. The computer readable medium of claim 8, the method further comprising:
receiving an application for a job posting included in the job search results from the user;
determining that at least one person in the user's social network works for an employer associated with the job posting; and
requesting a referral from the at least one person.

11. The computer readable medium of claim 8, the method further comprising:
accessing a plurality of social network accounts for the user to determine employers of contacts in the user's social networks;
for each job search result, determining the number of contacts in the user's social networks that work for the employer associated with the job search result; and
ranking the job search results based at least in part on the number of contacts in the user's social networks that work for employers associated with the job search results.

12. The computer readable medium of claim 11, the method further comprising:
combining contacts from the plurality of social network accounts for the user and removing any redundant contacts.

13. The computer readable medium of claim 8, the method further comprising:
determining a number of contacts in the user's social network who previously worked for the employer; and
ranking the job search results based at least in part on the number of contacts in the user's social network that previously worked for the employers associated with the job search results.

14. The computer readable medium of claim 8, wherein providing the ranked search results to the user comprises:
placing a subset of the ranked search results into a queue associated with the user based on the ranking; and
sending a first job search result in the queue to a mobile phone of the user.

15. A computing apparatus comprising:
a memory to store instructions for a job server; and
a processing device to execute the instructions, wherein the instructions cause the processing device to:
generate job search results for a user;
access a social network account of the user to determine employers of contacts in the user's social network;
for each job search result, determine a number of contacts in the user's social network that work for an employer associated with the job search result;
rank the job search results based at least in part on the number of contacts in the user's social network that work for employers associated with the job search results; and
provide the ranked search results to the user.

16. The computing apparatus of claim 15, further comprising the instructions to cause the processing device to:
receiving an application for a job posting included in the job search results from the user;
receive applications for the job posting from a plurality of additional users;
access social network accounts of the plurality of additional users to determine employers of contacts in social networks of the plurality of additional users; and
rank the user and the plurality of additional users based at least in part on number of contacts in the users' social networks that work for an employer associated with the job posting.

17. The computing apparatus of claim 15, further comprising the instructions to cause the processing device to:
receive an application for a job posting included in the job search results from the user;
determine that at least one person in the user's social network works for an employer associated with the job posting; and
request a referral from the at least one person.

18. The computing apparatus of claim 15, further comprising the instructions to cause the processing device to:
access a plurality of social network accounts for the user to determine employers of contacts in the user's social networks;
for each job search result, determine the number of contacts in the user's social networks that work for the employer associated with the job search result; and
rank the job search results based at least in part on the number of contacts in the user's social networks that work for employers associated with the job search results.

19. The computing apparatus of claim 18, further comprising the instructions to cause the processing device to:
combine contacts from the plurality of social network accounts for the user and remove any redundant contacts.

20. The computing apparatus of claim 15, further comprising the instructions to cause the processing device to:
determine a number of contacts in the user's social network who previously worked for the employer; and
rank the job search results based at least in part on the number of contacts in the user's social network that previously worked for the employers associated with the job search results.

21. The computing apparatus of claim 15, wherein providing the ranked search results to the user comprises:
place a subset of the ranked search results into a queue associated with the user based on the ranking; and
send a first job search result in the queue to a mobile phone of the user.
